(19) United States
(12) Patent Application Publication
(10) Pub. No.: US 2021/0065730 A1
(43) Pub. Date: Mar. 4, 2021

(54) ELECTRONIC SYSTEM WITH POWER-SAVING ECHO CANCELLATION AND RELATED ECHO CANCELLATION METHOD

(71) Applicant: Realtek Semiconductor Corp., HsinChu (TW)

(72) Inventors: Yu-Lien Lin, Hsinchu City (TW); Ta-Chin Tseng, New Taipei City (TW); Ching-Yao Su, Hsinchu County (TW); Ching-Pei Huang, Taichung City (TW)

(21) Appl. No.: 16/836,964

(22) Filed: Apr. 1, 2020

(30) Foreign Application Priority Data
Sep. 3, 2019 (TW) 108131628

(51) Int. Cl. G10L 21/0208; H04R 3/02

(52) U.S. Cl. CPC G10L 21/0208; G10L 2021/02082; H04R 3/02

(57) ABSTRACT

An electronic system includes an echo canceller, a calculation unit, and a control circuit. The echo canceller includes a plurality of operational segments and is configured to perform echo cancellation in a data mode or a power-saving mode. Based on the power of each operational segment provided by the calculation unit, the control circuit is configured to deactivate each stage whose power is lower than a threshold value when the echo canceller is performing echo cancellation in the power-saving mode.

### CROSS REFERENCE TO RELATED APPLICATION

This application claims priority of Taiwan Application No. 108131628 filed on 2019 Sep. 3.

### BACKGROUND OF THE INVENTION

### 1. Field of the Invention

The present invention is related to an electronic system with echo cancellation and related echo cancellation method, and more particularly, to an electronic system with power-saving echo cancellation and related echo cancellation method.

### 2. Description of the Prior Art

With rapid development in network technology, instant messaging and video communication applications are surging in popularity and demanding higher voice quality. In the above-mentioned applications, microphones and speakers are used to receive and transmit audio signal. When picking up an audio signal from a far-end speaker, a far-end microphone sends it to a near-end speaker. An electrically generated echo may occur when the incoming energy from the far-end speaker is reflected back toward the far-end speaker as a slightly altered and delayed replication due to impedance mismatch in the environment. When an echo becomes audible, it can critically impair voice quality, making phones calls very unpleasant and distracting, and very often even to the point of non-comprehension of the conversation.

In order to improve subjective voice quality, an echo canceller may be used to simulate the impulse response of the echo path. Echo cancellation involves first recognizing the originally transmitted far-end signal that re-appears, with some delay, in the transmitted or received signal by the near-end microphone. Once the echo is recognized, it can be removed by subtracting it from the transmitted or received signal by the near-end microphone. However, an automotive electronic system is an embedded system with a limited amount of resources, wherein a large percentage of the overall power consumption is due to performing echo cancellation. Therefore, there is a need for an electronic system with power-saving and high-efficient echo cancellation mechanism.

### SUMMARY OF THE INVENTION

The present invention provides a method of performing power-saving echo cancellation. An echo canceller including M operational segments operates in a power-saving mode by deactivating m operational segments among the M operational segments so as to allow (M-m) operational segments among the M operational segments to perform echo cancellation. The echo canceller enters a data mode by activating the M operational segments for performing echo cancellation when a condition is satisfied, wherein M is an integer larger than 1 and m is a positive integer smaller than M.

The present invention also provides an electronic system with power-saving echo cancellation mechanism. The electronic system includes an echo canceller, a calculation unit and a control circuit. The echo canceller includes M operational segments and is configured to perform echo cancellation in a data mode or in a power-saving mode. The calculation unit is configured to calculate a power of each operational segment among the M operational segments. The control circuit is configured to deactivate m operational segments among the M operational segments so as to allow (M−m) operational segments among the M operational segments to perform echo cancellation in the power-saving mode. A power of each of the m operational segments among the M operational segments is smaller than a threshold value. M is an integer larger than 1, and m is a positive integer smaller than M.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function diagram illustrating an electronic system with power-saving echo cancellation mechanism according to an embodiment of the present invention.

FIG. 2 is a diagram illustrating an implementation of an echo canceller according to an embodiment of the present invention.

FIG. 3 is a flowchart illustrating the operation of an electronic system according to an embodiment of the present invention.

FIG. 4 is a flowchart illustrating the operation of an electronic system according to another embodiment of the present invention.

### DETAILED DESCRIPTION

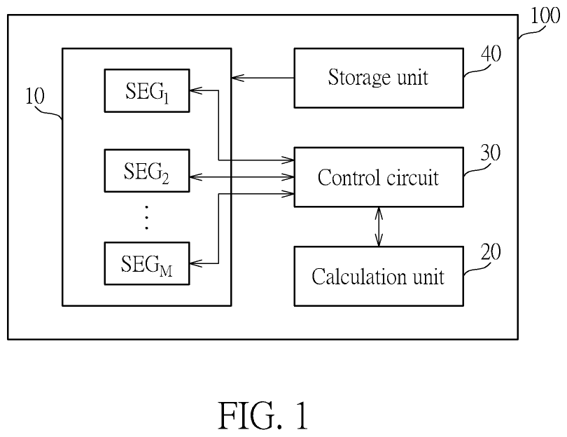

FIG. 1 is a function diagram illustrating an electronic system 100 with power-saving echo cancellation mechanism according to an embodiment of the present invention. The electronic system 100 includes an echo canceller 10, a calculation unit 20, a control circuit 30, and a storage unit 40. The echo canceller 10 includes a plurality of operational segments SEG₁˜SEG_{M} each capable of performing echo cancellation independently, wherein M is an integer larger than 1. The control circuit 30 is configured to transmit the coefficient of each operational segment to the calculation unit 20. According to the coefficient of each operational segment, the calculation unit 20 is configured to calculate the power of each operational segment and then send the calculated data to the control circuit 30. Next, the control circuit 30 is configured to activate or deactivate the operational segments SEG₁˜SEG_{M} according to whether the power of a corresponding operational segment is smaller than a threshold value. The storage unit 40 is configured to store data for operating the electronic system 100.

In the present invention, the echo canceller 10 may operate in a data mode and a power-saving mode. When operating in the data mode, all operational segments SEG₁˜SEG_{M} in the echo canceller 10 are activated so that a total of M operational segments are performing echo cancellation. When operating in the power-saving mode, m operational segments among the operational segments SEG₁˜SEG_{M} in the echo canceller 10 are deactivated so that a total of (M-m) operational segments are performing echo cancellation, wherein m is a positive integer smaller than M.

In an embodiment, the control circuit 30 may use registers to control the activation or deactivation of each operational segment in the echo canceller 10. However, the method of activating or deactivating each operational segment in the echo canceller 10 does not limit the scope of the present invention.

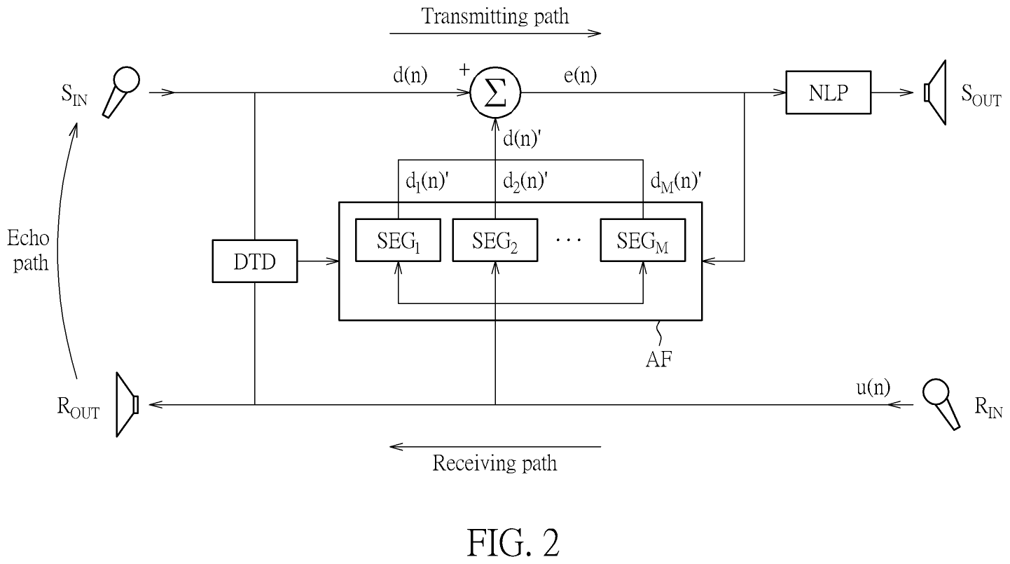

FIG. 2 is a diagram illustrating an implementation of the echo canceller 10 according to an embodiment of the present invention. A microphone receives an input signal on a near end S_{IN}, a speaker provides an output signal on a near end R_{OUT}, a microphone receives an input signal on a far end R_{IN}, and a speaker provides an output signal on a far end S_{OUT}. A receiving path is formed from the far end R_{IN} to the far end R_{OUT}, an echo path is formed from the near end R_{OUT} to the near end S_{IN}, and a transmitting path is formed from the near end S_{IN} to the far end S_{OUT}. The echo canceller 10 may include an adaptive filter AF, a double talk detector DTD, and a non-linear processor NLP.

The adaptive filter AF is configured to learn the impulse response of the echo path in the environment in which the electronic system 100 is located, thereby providing a corresponding estimated echo signal d(n)′. Based on the statistic characteristics of input/output signals, the adaptive filter AF may automatically adjust the filter coefficients using a specific algorithm in order to achieve optimum filter characteristics. More specifically, the adaptive filter AF may update and adjust the weighting coefficient for each sampled value of an input signal u(n) using the specific algorithm so that its estimated echo signal d(n)′ approximates an expected error signal e(n). As previously stated, the adaptive filter AF may be implemented as a plurality of operational segments SEG₁˜SEG_{M} for learning the impulse response of the echo path in its environment, thereby providing respective estimated echo signals d₁(n)′˜d_{M}(n)′, wherein d(n)′=d₁(n)′+d₂ (n)′+ . . . +d_{M}(n)′.

In an embodiment of the present invention, the adaptive filter AF may perform echo evaluation on the original far-end signal u(n) using a least mean square (LMS) algorithm, a normalized least mean square (NLMS) algorithm, a recursive least square (RLS) algorithm, or another algorithm. However, the algorithm adopted by the adaptive filter AF does not limit the scope of the present invention.

The double talk detector DTD is configured to determine whether the electronic system 100 is in a single-talk state or in a double-talk state. If the double talk detector DTD is unable to detect any input signal on the near end S_{IN} while the original signal u(n) is being inputted to the far end R_{IN}, it is determined that the electronic system 100 is in the single-talk state. If the double talk detector DTD detects an input signal on the near end S_{IN} while the original signal u(n) is being inputted to the far end R_{IN}, it is determined that the electronic system 100 is in the double-talk state.

In the single-talk state, the adaptive filter AF may perform echo evaluation on the original far-end signal u(n) using the specific algorithm. After space reflection, the original signal u(n) outputted from the near end R_{OUT} by the speaker may be inputted to the microphone on the near end S_{IN}, thereby resulting in a near-end echo signal d(n). The error signal e(n) may then be acquired by subtracting the estimated echo signal d(n)′ outputted by the adaptive filter AF from the near-end echo signal d(n). In an ideal scenario of echo cancellation, the estimated echo signal d(n)′ outputted by the adaptive filter AF is equal to the near-end echo signal d(n), which means the error signal e(n) is ideally 0. Therefore, each of the operational segments SEG₁˜SEG_{M} in the adaptive filter AF may continuously adjust its coefficient according to the original far-end signal u(n) and the error signal e(n) until the value of the error signal e(n) is reduced to 0. Under such circumstance, the adaptive filter AF may operate using converged optimum filter coefficients.

In the double-talk state, when both the near end S_{IN} and the far end R_{IN} receive input signals, the double talk detector DTD is configured to stop the learning process of the adaptive filter AF by cutting off the feedback path of the adaptive filter AF, thereby preventing the impulse response of the echo path simulated by the adaptive filter AF from diverging.

The non-linear processor NLP is configured to further eliminate residual echo. The non-linear processor NLP may be implemented to pass signals larger than a threshold value T_{SUP}, and reduce signals not larger than the threshold value T_{SUP} to zero or to a suppressed value. However, the design of the non-linear processor NLP does not limit the scope of the present invention.

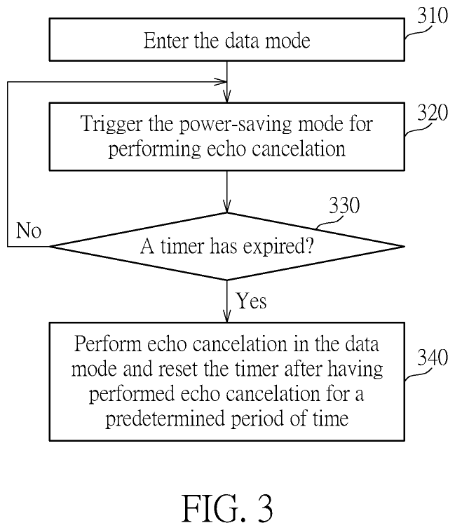

FIG. 3 is a flowchart illustrating the operation of the electronic system 100 according to an embodiment of the present invention. The flowchart in FIG. 3 includes the following steps:

Step 310: enter the data mode; execute step 320.

Step 320: trigger the power-saving mode for performing echo cancellation; execute step 330.

Step 330: determine whether a timer has expired; if yes, execute step 340; if no, execute step 320.

Step 340: perform echo cancellation in the data mode and reset the timer after having performed echo cancellation for a predetermined period of time; execute step 320.

In step 310 when operating in the data mode, all operational segments SEG₁˜SEG_{M} in the echo canceller 10 are activated for performing echo cancellation. In step 320 when operating in the power-saving mode, m operational segments among the operational segments SEG₁˜SEG_{M} in the echo canceller 10 are deactivated so that only (M−m) operational segments are performing echo cancellation. As depicted in FIG. 1, the control circuit 30 is configured to transmit the coefficient of each operational segment to the calculation unit 20 for calculating the power PW₁˜PW_{M} of the operational segments SEG₁˜SEG_{M}. Then, the control circuit 30 may determine whether the power of each operational segment exceeds the threshold value TH and deactivates all operational segments whose power is not larger than the threshold value TH in the power-saving mode. For example, if the power PW₁ of the operational segment SEG₁ exceeds the threshold value TH, it means that the operational segment SEG₁ is currently having a large computational load, and the control circuit 30 is thus configured to activate the operational segment SEG₁ for maintaining the overall efficiency of echo path learning. On the other hand, if the power PW₁ of the operational segment SEG₁ does not exceed the threshold value TH, it means that the operational segment SEG₁ is currently having a small computational load which is negligible to the overall efficiency of echo path learning, and the control circuit 30 is thus configured to deactivate the operational segment SEG₁ for reducing power consumption. In other words, when the electronic system 100 is operating in the power-saving mode, the control circuit 30 is configured to deactivate all operational segments whose power does not exceed the threshold value TH, thereby reducing power consumption while maintaining the overall efficiency of echo path learning.

The impulse response of echo path learning is the convergence process of the adaptive filter AF. Once any environmental change influences the echo path of the electronic system 100, the echo canceller is required to re-learn the impulse response of the echo path in the new environment, which means that the adaptive filter AF requires a new convergence process for approximating the impulse response of the new echo path. When the power-saving mode is triggered in step 320 for performing echo cancellation, the adaptive filter AF may not be able to converge efficiently in response to environmental changes since not all the operational segments in the echo canceller 10 are activated.

Therefore, after determining that the timer has expired in step 330, the echo canceller 10 is configured to perform echo cancellation in the data mode for the predetermined period of time in step 340. In other words, after having performed echo cancellation in the power-saving mode for a period of time indicated by the timer, the echo canceller 10 is configured to perform echo cancellation in the data mode for the predetermined period of time. Therefore, when encountering environmental changes in the echo path, all operational segments in the echo canceller 10 are functional for achieving efficient convergence to stability.

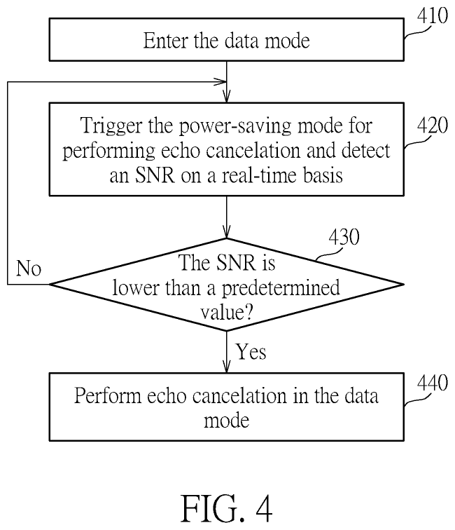

FIG. 4 is a flowchart illustrating the operation of the electronic system 100 according to another embodiment of the present invention. The flowchart in FIG. 4 includes the following steps:

Step 410: enter the data mode; execute step 420.

Step 420: trigger the power-saving mode for performing echo cancellation and detect a signal-to-noise ratio (SNR) on a real-time basis; execute step 430.

Step 430: determine whether the SNR is lower than a predetermined value; if yes, execute step 440; if no, execute step 420.

Step 440: perform echo cancellation in the data mode; execute step 420.

In step 410 when operating in the data mode, all operational segments SEG₁˜SEG_{M} in the echo canceller 10 are activated for performing echo cancellation. In step 420 when operating in the power-saving mode, m operational segments among the operational segments SEG₁˜SEG_{M} in the echo canceller 10 are deactivated so that only (M−m) operational segments are performing echo cancellation. Also, the electronic system 100 is configured to detect the SNR on a real-time basis in step 410 and then determine whether the SNR is lower than the predetermined value in step 430.

When determining that the SNR is not lower than the predetermined value, it means that all activated operational segments are operating in a converged state, and step 420 is thus executed for performing echo cancellation in the power-saving mode. When determining that the SNR is lower than the predetermined value, it means that the impulse response of the echo path in the environment of the electronic system 100 may be changed due to transmission length, temperature, noise or other external environmental factors, and that the echo canceller 10 may start to diverge and thus unable to provide sufficient echo cancellation. Under such circumstance, step 440 is executed for performing echo cancellation in the data mode, thereby achieving efficient convergence to stability.

In the present invention, the adaptive filter may be implemented as a plurality of operational segments. The operational segments with small computational load may be deactivated in the power-saving mode for reducing power consumption while maintaining the overall efficiency of echo path learning. Therefore, the present invention provides an electronic system with power-saving and high-efficient echo cancellation mechanism.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing power-saving echo cancellation, comprising:
an echo canceller including M operational segments operating in a power-saving mode by deactivating m operational segments among the M operational segments so as to allow (M−m) operational segments among the M operational segments to perform echo cancellation; and
the echo canceller entering a data mode by activating the M operational segments for performing echo cancellation when a condition is satisfied, wherein M is an integer larger than 1 and m is a positive integer smaller than M.

2. The method of claim 1, further comprising:
determining whether a timer has expired when the echo canceller is performing echo cancellation in the power-saving mode; and
determining that the conditioned is satisfied when the timer has expired.

3. The method of claim 2, further comprising:
resetting the timer and the echo canceller entering the power-saving mode after the echo canceller has been performing echo cancellation in the data mode longer than a predetermined period of time.

4. The method of claim 1, further comprising:
detecting a signal-to-noise ratio when the echo canceller is performing echo cancellation in the power-saving mode; and
determining that the conditioned is satisfied when the signal-to-noise ratio is smaller than a predetermined value.

5. The method of claim 4, further comprising:
when determining that the signal-to-noise ratio is not smaller than the predetermined value in the data mode, the echo canceller entering the power-saving mode.

6. The method of claim 1, further comprising
calculating a power of each operational segment based on a coefficient of each operational segment, wherein the power of each operational segment among the m operational segments which is deactivated in the power-saving mode is smaller than a threshold value.

7. An electronic system with power-saving echo cancellation mechanism, comprising:
an echo canceller including M operational segments and configured to perform echo cancellation in a data mode or in a power-saving mode;
a calculation unit configured to calculate a power of each operational segment among the M operational segments; and
a control circuit configured to deactivate m operational segments among the M operational segments so as to allow (M−m) operational segments among the M operational segments to perform echo cancellation in the power-saving mode, wherein:
a power of each of the m operational segments among the M operational segments is smaller than a threshold value;
M is an integer larger than 1; and
m is a positive integer smaller than M.

8. The electronic system of claim 7, wherein the M operational segments form an adaptive filter configured to adjust a first through an M^{th} coefficients according to an original far-end signal and an error signal, and generate a first through an M^{th} estimated echo signals.

9. The electronic system of claim 8, wherein:
the echo canceller is further configured to generate the error signal by subtracting an overall estimated echo signal from a near-end echo signal; and
the overall estimated echo signal is a sum of the first through an M^{th} estimated echo signals.

10. The electronic system of claim 8, wherein:
the control circuit is further configured to transmit a coefficient of each operational segment to the calculation unit; and
the calculation unit is further configured to calculate a power of each operational segment according to the coefficient of each operational segment.
